(19) United States
(12) Patent Application Publication
(10) Pub. No.: US 2024/0157464 A1
(43) Pub. Date: May 16, 2024

(54) TWO-WAY WELDING GUN

(71) Applicants: Hyundai Motor Company, Seoul (KR); Kia Corporation, Seoul (KR); OBARA KOREA CORPORATION, Hwaseong-si (KR)

(72) Inventors: Yoon Gi HONG, Gwangmyeong-Si (KR); Byoung Joo KIM, Gwangmyeong-Si (KR); Chang Kun JEONG, Ulsan (KR); Man Soo YUN, Hwaseong-Si (KR)

(73) Assignees: Hyundai Motor Company, Seoul (KR); Kia Corporation, Seoul (KR); OBARA KOREA CORPORATION, Hwaseong-si (KR)

(21) Appl. No.: 18/129,471

(22) Filed: Mar. 31, 2023

(30) Foreign Application Priority Data
Nov. 15, 2022 (KR) 10-2022-0152279

(51) Int. Cl. B23K 11/31; B23K 11/11

(52) U.S. Cl. CPC B23K 11/314; B23K 11/115; B23K 11/318

(57) ABSTRACT

A two-way welding gun includes a first welding tip or a second welding tip selected to be used depending on the shape of the flange of a vehicle body panel, which is an object for the spot welding, so that flanges of first vehicle body panels each including a shape matching the first welding tip are easily spot welded to each other using the first welding tip, and flanges of second vehicle body panels each including a shape different from the first welding tip but matching the second welding tip are easily spot welded to each other using the second welding tip.

### CROSS-REFERENCE TO RELATED APPLICATION

The present application claims priority to Korean Patent Application No. 10-2022-0152279, filed on Nov. 15, 2022, the entire contents of which is incorporated herein for all purposes by this reference.

### BACKGROUND OF THE PRESENT DISCLOSURE

### Field of the Present Disclosure

The present disclosure relates to a two-way welding gun. More particularly, it relates to a two-way welding gun capable of allowing a user to select and use an appropriate welding tip depending on the shape of an object for the spot welding.

### Description of Related Art

Generally, spot welding is mainly used in manufacturing and assembling vehicle body panels.

Spot welding is one of welding methods in which two or more metal plates are placed between a movable electrode and a fixed electrode, and then the two or more metal plates are joined using pressure and heat by applying current to the movable electrode and the fixed electrode.

A related art spot welding process to bond vehicle body panels to each other is performed using a spot welding gun provided with a welding tip having a defined shape.

However, because the welding tip of the related art spot welding gun is provided in advance in a defined shape to match the shape of the flange of the vehicle body panel, which is an object of spot welding, there is a problem that spot welding cannot be performed on vehicle body panels each provided with a flange having a different shape than the welding tip.

In other words, for flanges of first vehicle body panels each having a shape matching a welding tip having a defined shape, spot welding may be easily performed on the flanges of the first vehicle body panels. However, for flanges of second vehicle body panels each having a shape different from the welding tip having the defined shape, spot welding cannot be performed on the flanges of the second vehicle body panels using the welding tip having the defined shape.

For the present reason, at least two types of spot welding guns having different shapes of welding tips must be used in order to perform spot welding on the flanges of vehicle body panels having various shapes. Accordingly, additional facilities and costs are needed for a spot welding gun, and a robot, a controller, and the like configured to operate the same, and problems such as a decrease in efficiency in arranging the welding space ensue.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a two-way welding gun in which a first welding tip or a second welding tip may be selected to be used depending on the shape of the flange of a vehicle body panel, which is an object for the spot welding, so that flanges of first vehicle body panels each including a shape matching the first welding tip may be easily spot welded to each other using the first welding tip, and flanges of second vehicle body panels each including a shape different from the first welding tip but matching the second welding tip may be easily spot welded to each other using the second welding tip.

The object of the present disclosure is not limited to the object mentioned above, and other objects not mentioned herein will be clearly understood by those of ordinary skill in the art to which an exemplary embodiment of the present disclosure pertains (hereinafter, “those skilled in the art”) based on the description below.

Various aspects of the present disclosure are directed to providing a two-way welding gun including a power supply configured to supply power for spot welding, an arm connected to the front end portion of the power supply, a holder mounted on the front end portion of the arm, a fixed welding tip mounted on the holder, a pressure cylinder mounted on the lower portion of the power supply, and a welding tip adjuster, mounted to a piston rod of the pressure cylinder to be movable forwards and rearwards and configured to selectively rotate a first welding tip or a second welding tip to a position in line with the fixed welding tip depending on the shape of an object for the spot welding.

In an exemplary embodiment of the present disclosure, the welding tip adjuster may include a base block mounted on the front end portion of the piston rod, a rotary block rotatably mounted on the base block by a hinge pin, a first welding tip mounted on the front end portion of the rotary block, a second welding tip mounted on the upper end portion of the rotary block, and an actuator connected to the rotary block to selectively rotate the rotary block to a first position where the first welding tip is in line with the fixed welding tip, or to rotate the rotary block to a second position where the second welding tip is in line with the fixed welding tip.

In another exemplary embodiment of the present disclosure, the first welding tip may have a diameter equal or similar to a diameter of the fixed welding tip.

In yet another exemplary embodiment of the present disclosure, the second welding tip may have a diameter smaller than that of the fixed welding tip.

In yet another exemplary embodiment of the present disclosure, the second welding tip may have an end portion including a pointed shape and have an end surface having a long rectangular shape, through a cutting process.

In still yet another exemplary embodiment of the present disclosure, to define a position where the first welding tip is in line with the fixed welding tip, the rotary block may have one side including a first rotary stopper mounted at a predetermined position thereof, and the base block may have one side including a first fixed stopper, the first fixed stopper being brought into contact with the first rotary stopper, mounted at an upper position thereof.

In a further exemplary embodiment of the present disclosure, the first rotary stopper may have formed therein a first catch groove into which the first fixed stopper is selectively inserted.

In another further exemplary embodiment of the present disclosure, to define a position where the second welding tip is in line with the fixed welding tip, the rotary block may have one side including a second rotary stopper mounted at a predetermined position thereof, and the base block may have one side including a second fixed stopper, the second fixed stopper being brought into contact with the second rotary stopper, mounted at a lower position thereof.

In yet another further exemplary embodiment of the present disclosure, the second rotary stopper may have formed therein a second catch groove into which the second fixed stopper is selectively inserted.

In yet another further exemplary embodiment of the present disclosure, the actuator may include a support bracket mounted on the lower portion of the base block, a tilting cylinder tiltably hinged to the support bracket, and a push-pull piston rod, the push-pull piston rod being a piston rod of the tilting cylinder, hinged to the lower portion of the front end side of the rotary block.

Other aspects and exemplary embodiments of the present disclosure are discussed infra.

It is to be understood that the term “vehicle” or “vehicular” or other similar terms as used herein are inclusive of motor vehicles in general, such as passenger automobiles including sports utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The above and other features of the present disclosure are discussed infra.

### BRIEF DESCRIPTION OF THE DRAWINGS

FIG. 1 is a perspective view of a two-way welding gun according to an exemplary embodiment of the present disclosure viewed from one side;

FIG. 2 is a perspective view of the two-way welding gun according to an exemplary embodiment of the present disclosure viewed from a side opposite to the one side of FIG. 1;

FIG. 3 is a side view exemplarily illustrating a state in which a first welding tip of a two-way welding gun according to an exemplary embodiment of the present disclosure is rotated to a weldable position;

FIG. 4 is a cross-sectional view exemplarily illustrating a state in which a flange of a vehicle body panel is spot-welded using a first welding tip and a fixed welding tip of a two-way welding gun according to an exemplary embodiment of the present disclosure;

FIG. 5 is a side view exemplarily illustrating a state in which a second welding tip of a two-way welding gun according to an exemplary embodiment of the present disclosure is rotated to a weldable position; and

FIG. 6 is a cross-sectional view exemplarily illustrating a state in which a flange of a vehicle body panel is spot-welded using a second welding tip and a fixed welding tip of a two-way welding gun according to an exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes, will be determined in part by the particular intended application and usage environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, exemplary embodiments of the present disclosure will be described with reference to the accompanying drawings.

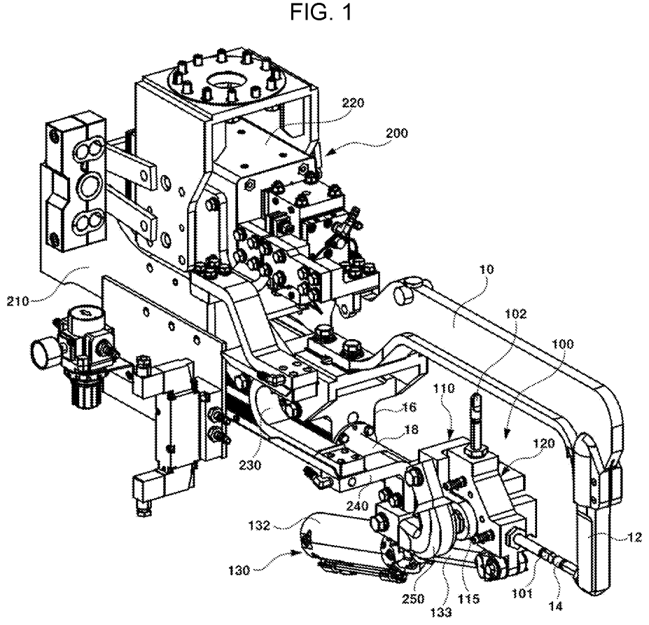

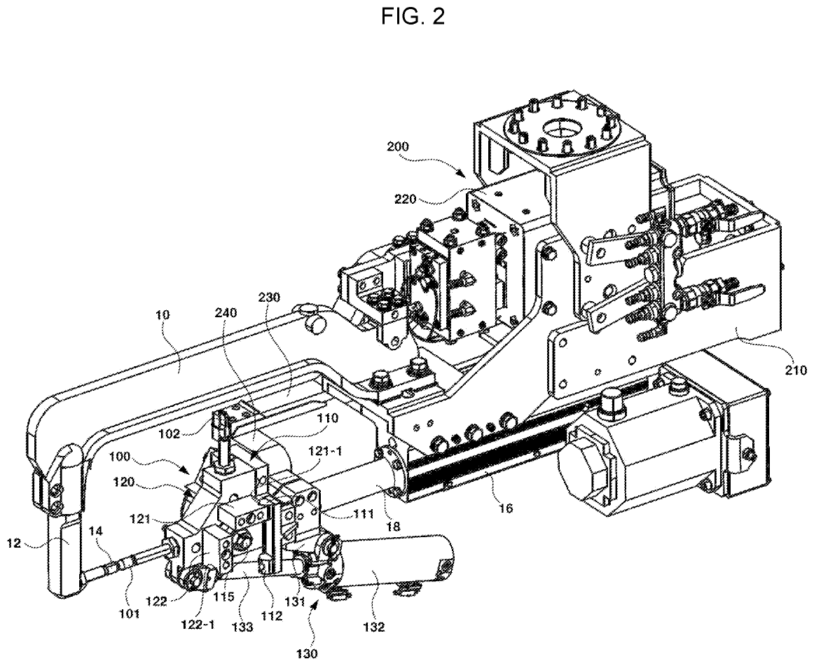

FIG. 1 is a perspective view of a two-way welding gun according to an exemplary embodiment of the present disclosure viewed from one side, and FIG. 2 is a perspective view of the two-way welding gun according to an exemplary embodiment of the present disclosure viewed from a side opposite to the one side of FIG. 1. Reference numeral 200 in each drawing denotes a power supply.

The power supply 200 is mounted on a base frame 210 and is configured to supply power for spot welding to a welding tip.

The base frame 210 is a portion connected to a robot. The base frame 210 has a front end portion to which an arm 10, including a bar shape and extending forwards, is connected, and the arm 10 has a front end portion to which a holder 12, configured to fix a welding tip, is mounted.

Here, the holder 12 has an upper end portion mounted to the front end portion of the arm 10, so that the holder 12 is arranged in a vertical direction.

The holder 12 has a lower end portion to which a fixed welding tip 14 is horizontally fixed on a rear surface thereof.

Meanwhile, the power supply 200 has a lower portion, i.e., the lower portion of the base frame 210, on which a pressure cylinder 16 is mounted, and the pressure cylinder 16 includes a piston rod 18 configured to linearly move forwards and rearwards thereof.

The piston rod 18 of the pressure cylinder 16 includes a welding tip adjuster 100 mounted thereto to be movable forwards and rearwards thereof. The welding tip adjuster 100 is configured to selectively rotate a first welding tip 101 or a second welding tip 102 to a position in line with the fixed welding tip 14 depending on the shape of an object for the spot welding.

Hereinafter, each of components of the welding tip adjuster 100 and a coupling relationship thereof will be described in detail.

A base block 110, which is one component of the welding tip adjuster 100, is mounted on the front end portion of the piston rod 18 to be movable forwards and rearwards thereof.

Furthermore, the base block 110 has one side to which a rotary block 120 is rotatably mounted by a hinge pin 115.

Accordingly, when the piston rod 18 moves forwards by the operation of the pressure cylinder 16, the base block 110 and the rotary block 120 may move forwards together therewith, and when the piston rod 18 moves rearwards by the operation of the pressure cylinder 16, the base block 110 and the rotary block 120 may move rearwards together therewith.

With respect to the orientation (orientation in FIG. 1 and FIG. 2) in a state in which the rotary block 120 is placed at an original position thereof, the rotary block 120 has a front end portion on which the first welding tip 101 is mounted and has an upper end portion on which the second welding tip 102, in which a specification different from the first welding tip 101 is adopted, is mounted.

The first welding tip 101 mounted on the front end portion of the rotary block 120 and the second welding tip 102 mounted on the upper end portion of the rotary block 120 may be arranged at right angles (about 90°) to each other.

The first welding tip 101 may be used when a flange 310 of a vehicle body panel 300 (e.g., a door panel), which is an object for the spot welding, has a width equal to or greater than a predetermined width, as illustrated in FIG. 4. The first welding tip 101 may have a diameter equal or similar to a diameter of the fixed welding tip 14.

Accordingly, the end surface of the first welding tip 101 and the end surface of the fixed welding tip 14 facing each other may be brought into close contact with the flange 310 interposed therebetween, and have the same contact area.

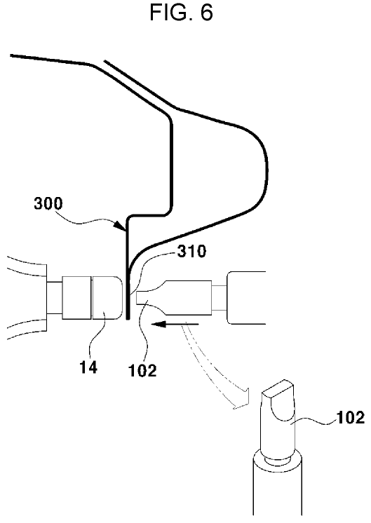

On the other hand, the second welding tip 102 may be used when the flange 310 of the vehicle body panel 300 (e.g., a door panel), which is an object for the spot welding, has a width smaller than a predetermined width, as illustrated in FIG. 6. The second welding tip 102 may have a diameter smaller than that of the fixed welding tip 14.

The second welding tip 102 may have an end portion including a pointed shape and may have an end surface having a long rectangular shape, through a cutting process.

Accordingly, when the flange 310 of the vehicle body panel 300, which is an object for the spot welding, has a width equal to or greater than a predetermined width, spot welding is performed using the first welding tip 101 and the fixed welding tip 14. On the other hand, when the flange 310 of the vehicle body panel 300, which is an object for the spot welding, has a width smaller than a predetermined width to the extent that spot welding cannot be easily performed with the first welding tip 101, the second welding tip 102 and the fixed welding tip 14 are used to easily perform spot welding.

To the present end, the welding tip adjuster 100 includes an actuator 130 configured to rotate the rotary block 120 to a position where the first welding tip 101 is in line with the fixed welding tip 14, or rotate the rotary block 120 to a position where the second welding tip 102 is in line with the fixed welding tip 14.

The actuator 130 may include a support bracket 131 mounted on the lower portion of the base block 110, a tilting cylinder 132 tiltably hinged to the support bracket 131, and a push-pull piston rod 133, which is a piston rod of the tilting cylinder 132.

Here, the push-pull piston rod 133 of the tilting cylinder 132 has an end portion hinged to the lower portion of the front end side of the rotary block 120.

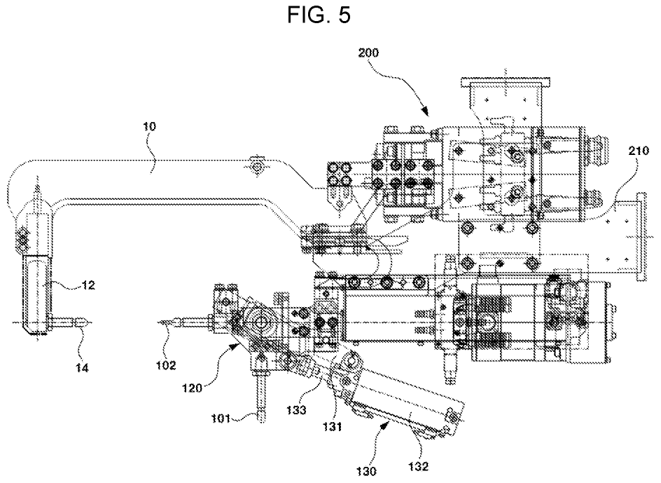

Accordingly, when the push-pull piston rod 133 moves rearwards by operation of the tilting cylinder 132 and simultaneously pulls the rotary block 120, the rotary block 120 rotates about 90° forwards about the hinge pin 115, allowing the second welding tip 102 mounted on the upper end portion of the rotary block 120 to rotate to a welding position which is in line with the fixed welding tip 14, and at the same time, allowing the first welding tip 101 mounted on the front end portion of the rotary block 120 to rotate to a position facing downwards, as illustrated in FIG. 5.

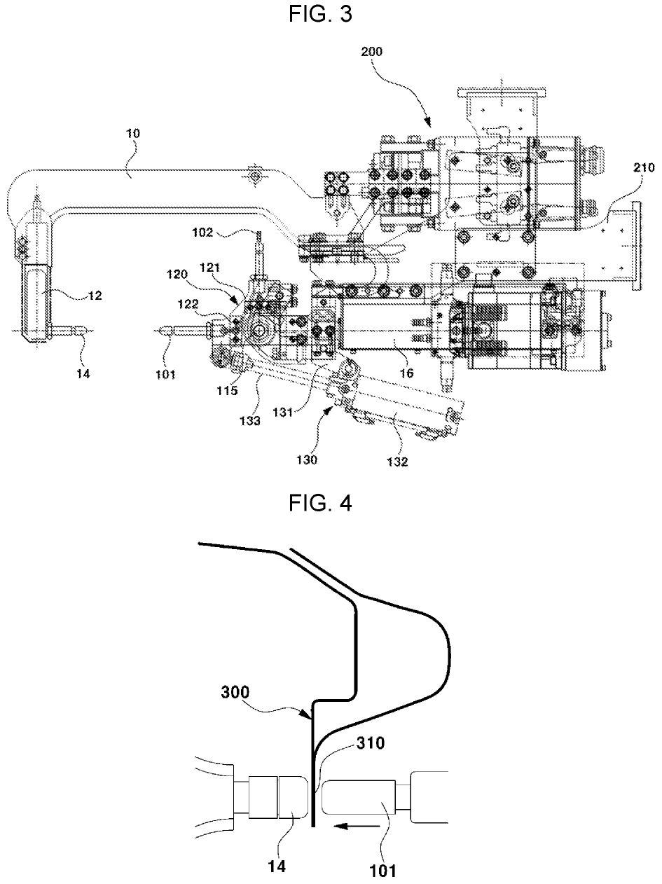

On the other hand, when the push-pull piston rod 133 moves forwards by operation of the tilting cylinder 132 and simultaneously pushes the rotary block 120, the rotary block 120 rotates about 90° rearwards about the hinge pin 115, allowing first welding tip 101 mounted on the front end portion of the rotary block 120 to rotate to a welding position which is in line with the fixed welding tip 14, and at the same time, allowing the second welding tip 102 mounted on the upper end portion of the rotary block 120 to rotate to a position facing upwards, as illustrated in FIG. 3.

Meanwhile, to define a position where the first welding tip 101 is in line with the fixed welding tip 14, as illustrated in FIG. 2, the rotary block 120 has one side including a first rotary stopper 121 mounted at a predetermined position thereof, the base block 110 has one side including a first fixed stopper 111, which is brought into contact with the first rotary stopper 121, mounted at an upper position thereof, and the first rotary stopper 121 has formed therein a first catch groove 121-1 into which the first fixed stopper 111 is inserted.

Accordingly, when the rotary block 120 is rotated to a position where the first welding tip 101 is in line with the fixed welding tip 14, the first fixed stopper 111 of the base block 110 is inserted into the first catch groove 121-1 in the first rotary stopper 121 rotating together with the rotary block 120, allowing the rotary block 120 to rotate only to a position where the first welding tip 101 is in line with the fixed welding tip 14 and limiting further rotation of the rotary block 120.

Meanwhile, to define a position where the second welding tip 102 is in line with the fixed welding tip 14, as illustrated in FIG. 2, the rotary block 120 has one side including a second rotary stopper 122 mounted at a predetermined position thereof, the base block 110 has one side including a second fixed stopper 112, which is brought into contact with the second rotary stopper 122, mounted at an upper position thereof, and the second rotary stopper 122 has formed therein a second catch groove 122-1 into which the second fixed stopper 112 is inserted.

Accordingly, when the rotary block 120 is rotated to a position where the second welding tip 102 is in line with the fixed welding tip 14, the second fixed stopper 112 of the base block 110 is inserted into the second catch groove 122-1 in the second rotary stopper 122 rotating together with the rotary block 120, allowing the rotary block 120 to rotate only to a position where the second welding tip 102 is in line with the fixed welding tip 14 and limiting further rotation of the rotary block 120.

Meanwhile, the power supply 200 may include, as illustrated in FIG. 1 and FIG. 2, a transformer 220 mounted at a predetermined position on the base frame 210, a shunt 230 electrically connected to the transformer 220, a bus bar 240 electrically connected to the shunt 230, and a power connecting cable 250 electrically connected to the bus bar 240.

Here, the power connecting cable 250 may be connected to the first and second welding tips 101 and 102 through the rotary block 120 to supply power to the first and second welding tips 101 and 102.

The operation flow of the two-way welding gun of the present disclosure including the above-described configuration is as follows.

FIG. 3 is a side view exemplarily illustrating a state in which a first welding tip of a two-way welding gun according to an exemplary embodiment of the present disclosure is rotated to a weldable position, and FIG. 4 is a cross-sectional view exemplarily illustrating a state in which a flange of a vehicle body panel is spot-welded using a first welding tip and a fixed welding tip of a two-way welding gun according to an exemplary embodiment of the present disclosure.

As illustrated in FIG. 4, when the flange 310 of the vehicle body panel 300, which is an object for the spot welding, has a width equal to or greater than a predetermined width, the first welding tip 101 having a diameter equal or similar to a diameter of the fixed welding tip 14 may be used for spot welding.

To the present end, when the push-pull piston rod 133 moves forwards by operation of the tilting cylinder 132 and simultaneously pulls the rotary block 120, the rotary block 120 rotates about 90° rearwards about the hinge pin 115, allowing the first welding tip 101 mounted on the front end portion of the rotary block 120 to rotate to a welding position which is in line with the fixed welding tip 14, and at the same time, allowing the second welding tip 102 mounted on the upper end portion of the rotary block 120 to be placed at a position facing upwards to be excluded from being welded, as illustrated in FIG. 3.

Here, when the rotary block 120 is rotated to a position where the first welding tip 101 is in line with the fixed welding tip 14, the first fixed stopper 111 is inserted into the first catch groove 121-1 in the first rotary stopper 121 to allow the rotary block 120 to rotate only to a position where the first welding tip 101 is in line with the fixed welding tip 14 and not to rotate any Furthermore, ensuring that the first welding tip 101 and the fixed welding tip 14 are in line with each other, which is a position where spot welding may be performed.

Subsequently, the flange 310 of the vehicle body panel 300, which is an object for the spot welding, is disposed between the end surface of the first welding tip 101 and the end surface of the fixed welding tip 14.

Next, when the piston rod 18 moves forwards by operation of the pressure cylinder 16 mounted on the lower portion of the base frame 210, the base block 110 and the rotary block 120 connected to the piston rod 18 move forwards together therewith, so that the first welding tip 101 mounted on the rotary block 120 is brought into contact with the fixed welding tip 14 with the flange 310 interposed therebetween.

Accordingly, power is supplied from the power supply 200 to the first welding tip 101, allowing spot welding on the flange 310 of the vehicle body panel 300, which is an object for the spot welding, to be easily performed.

FIG. 5 is a side view exemplarily illustrating a state in which the second welding tip of the two-way welding gun according to an exemplary embodiment of the present disclosure is rotated to a weldable position, and FIG. 6 is a cross-sectional view exemplarily illustrating a state in which the flange of the vehicle body panel is spot-welded using the second welding tip and the fixed welding tip of the two-way welding gun according to an exemplary embodiment of the present disclosure.

As illustrated in FIG. 6, when the flange 310 of the vehicle body panel 300, which is an object for the spot welding, has a width smaller than a predetermined width, the second welding tip 102 having a diameter smaller than that of the fixed welding tip 14 may be used for spot welding.

Here, as illustrated in FIG. 6, the second welding tip 102 including an end portion including a pointed shape and an end surface including a long rectangular shape through the cutting process may be used.

To the present end, when the push-pull piston rod 133 moves rearwards by operation of the tilting cylinder 132 and simultaneously pulls the rotary block 120, the rotary block 120 rotates about 90° forwards about the hinge pin 115, allowing the second welding tip 102 mounted on the upper end portion of the rotary block 120 to rotate to a welding position which is in line with the fixed welding tip 14, and at the same time, allowing the first welding tip 101 mounted on the front end portion of the rotary block 120 to be placed at a position facing downwards to be excluded from being welded, as illustrated in FIG. 5.

Here, when the rotary block 120 is rotated to a position where the second welding tip 102 is in line with the fixed welding tip 14, the second fixed stopper 112 is inserted into the second catch groove 122-1 in the second rotary stopper 122 to allow the rotary block 120 to rotate only to a position where the second welding tip 102 is in line with the fixed welding tip 14 and not to rotate any further, ensuring that the second welding tip 102 and the fixed welding tip 14 are in line with each other, which is a position where spot welding may be performed.

Subsequently, the flange 310 of the vehicle body panel 300, which is an object for the spot welding, is disposed between the end surface of the second welding tip 102 and the end surface of the fixed welding tip 14.

Next, when the piston rod 18 moves forwards by operation of the pressure cylinder 16 mounted on the lower portion of the base frame 210, the base block 110 and the rotary block 120 connected to the piston rod 18 move forwards together therewith, so that the second welding tip 102 mounted on the rotary block 120 is brought into close contact with the fixed welding tip 14 with the flange 310 interposed therebetween.

Accordingly, power is supplied from the power supply 200 to the second welding tip 102, allowing spot welding on the flange 310 of the vehicle body panel 300, which is an object for the spot welding, to be easily performed.

As described above, because the first welding tip 101 or the second welding tip 102 may be selected to be used depending on the width and shape of the flange 310 of the vehicle body panel 300, which is an object for the spot welding, spot welding may be easily performed on the flanges of vehicle body panels including various shapes and the effect of using two spot welding guns may be obtained using one spot welding gun, improving welding workability and productivity and reducing costs.

As is apparent from the above description, various aspects of the present disclosure are directed to providing the following effects.

First, a first welding tip or a second welding tip may be selected to be used depending on the width and shape of the flange of a vehicle body panel, which is an object for the spot welding, and thus spot welding may be easily performed on the flanges of vehicle body panels including various shapes, improving welding workability and productivity.

Second, the effect of using two spot welding guns may be obtained using one spot welding gun, minimizing additional facilities and costs for a spot welding gun and a robot, a controller, and the like configured to operate the same to thereby reduce costs, and improving the efficiency of arranging a welding space where the spot welding gun is provided.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A two-way welding gun apparatus comprising:
a power supply configured to supply power for spot welding;
an arm connected to a front portion of the power supply;
a holder mounted on one end portion of the arm;
a fixed welding tip mounted on the holder; and
a welding tip adjuster configured to selectively rotate a first welding tip or a second welding tip to a position in line with the fixed welding tip depending on a shape of an object for the spot welding.

2. The two-way welding gun apparatus of claim 1, further including:
a pressure cylinder mounted on the power supply,
wherein the pressure cylinder includes a piston rod to which the welding tip adjuster is connected to be movable forwards and rearwards thereof.

3. The two-way welding gun apparatus of claim 1, wherein the welding tip adjuster includes:
a base block mounted on a piston rod;
a rotary block rotatably mounted on the base block by a hinge pin;
the first welding tip mounted on a first side of the rotary block;
the second welding tip mounted on a second side of the rotary block; and
an actuator connected to the rotary block to selectively rotate the rotary block to a first position where the first welding tip is in line with the fixed welding tip, or to rotate the rotary block to a second position where the second welding tip is in line with the fixed welding tip.

4. The two-way welding gun apparatus of claim 1, wherein the first welding tip has a diameter equal or similar to a diameter of the fixed welding tip.

5. The two-way welding gun apparatus of claim 1, wherein the second welding tip has a diameter smaller than a diameter of the fixed welding tip.

6. The two-way welding gun apparatus of claim 5, wherein the second welding tip includes an end portion having a pointed shape and includes an end surface having a rectangular shape, through a cutting process.

7. The two-way welding gun apparatus of claim 3, wherein the rotary block includes a first rotary stopper mounted at a predetermined position at a side thereof, to define a position where the first welding tip is in line with the fixed welding tip, and the base block includes a first fixed stopper mounted at an upper position thereof, the first fixed stopper being brought into contact with the first rotary stopper.

8. The two-way welding gun apparatus of claim 7, wherein the first rotary stopper includes a first catch groove into which the first fixed stopper is selectively inserted.

9. The two-way welding gun apparatus of claim 3, wherein the rotary block includes a second rotary stopper mounted at a predetermined position at a side thereof, to define a position where the second welding tip is in line with the fixed welding tip, and the base block includes a second fixed stopper mounted at a lower position thereof, the second fixed stopper being brought into contact with the second rotary stopper.

10. The two-way welding gun apparatus of claim 9, wherein the second rotary stopper includes a second catch groove into which the second fixed stopper is selectively inserted.

11. The two-way welding gun apparatus of claim 3, wherein the actuator includes:
a support bracket mounted on a lower portion of the base block;
a tilting cylinder tiltably hinged to the support bracket; and
a push-pull piston rod, the push-pull piston rod being a piston rod of the tilting cylinder, hinged to a lower portion of a front end side of the rotary block.
